(19) United States
(12) Patent Application Publication
(10) Pub. No.: US 2026/0221629 A1
(43) Pub. Date: Jul. 30, 2026

(54) POWER STORAGE SYSTEM

(71) Applicant: TOYOTA JIDOSHA KABUSHIKI KAISHA, Toyota-shi (JP)

(72) Inventors: Kenji BABA, Seto-shi (JP); Kenji TAKAHASHI, Toyota-shi (JP); Yukichika ITO, Okazaki-shi (JP); Takuko TOCHI, Okazaki-shi (JP); Takahiro NIIMI, Kasugai-shi (JP)

(73) Assignee: TOYOTA JIDOSHA KABUSHIKI KAISHA, Toyota-shi (JP)

(21) Appl. No.: 19/414,610

(22) Filed: Dec. 10, 2025

(30) Foreign Application Priority Data
Jan. 24, 2025 (JP) 2025-010519

(51) Int. Cl. H01M 50/574; H01M 50/209; H01M 50/502

(52) U.S. Cl. CPC H01M 50/574; H01M 50/209; H01M 50/502

(57) ABSTRACT

A power storage system includes a plurality of power storage units, each including a plurality of battery packs, and a current collector unit connected to each of the power storage units to perform current collection, wherein each of the power storage units includes a first breaker and is connected to the current collector unit via the first breaker. The current collector unit is built into a first power storage unit from among the power storage units, includes a second breaker for connecting to each of second power storage units other than the first power storage unit, among the power storage units, is connected to the second power storage units via the first and second breakers, and is connected to the first power storage unit via just the first breaker.

### CROSS-REFERENCE TO RELATED APPLICATION

This application claims priority to Japanese Patent Application No. 2025-010519 filed on January 24, 2025. The disclosure of the above-identified application, including the specification, drawings, and claims, is incorporated by reference herein in its entirety.

### BACKGROUND

### 1. Technical Field

The present disclosure relates a power storage system.

### 2. Description of Related Art

Japanese Unexamined Patent Application Publication No. 2001-015090 (JP 2001-015090 A) discloses a stationary power storage device in which a plurality of battery packs is stacked in an up-down direction and housed in a box-shaped housing.

### SUMMARY

The inventors have developed a power storage system that includes a plurality of power storage units (power storage devices) and a current collector unit that is connected to each of the power storage units to perform current collection, and are studying reducing the size of the current collector unit.

The present disclosure has been made in light of the above circumstances, and provides a power storage system that enables a current collector unit to be reduced in size.

A power storage system according to an aspect of the present disclosure includes

a plurality of power storage units, each including a plurality of battery packs, and

a current collector unit connected to each of the power storage units to perform current collection, in which

each of the power storage units includes a first breaker and is connected to the current collector unit via the first breaker, and

the current collector unit

is built into a first power storage unit from among the power storage units,

includes a second breaker for connecting to each of second power storage units other than the first power storage unit, from among the power storage units,

is connected to each of the second power storage units via the first and the second breakers, and

is connected to the first power storage unit via just the first breaker.

In the power storage system according to the present disclosure, the current collector unit is built into the first power storage unit from among the power storage units, has the second breaker for connecting to each of the second power storage units other than the first power storage unit from among the power storage units, is connected to each of the second power storage units via the first and the second breakers, and is connected to the first power storage unit via just the first breaker. The current collector unit is built into the first power storage unit, and accordingly the entire power storage system can be made smaller, and also the current collector unit does not need to include the second breaker for the first power storage unit, whereby the current collector unit built into the first power storage unit can also be reduced in size.

In each of the power storage units, each of the battery packs may include a battery module that is substantially rectangular cuboid shaped, and a protrusion protruding upward from one end of the battery module, in which the battery packs may be stacked in an up-down direction and housed in a housing such that the protrusions are alternately disposed on opposite sides.

The present disclosure can provide a power storage system that enables the size of a current collector unit to be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a power storage system according to a first embodiment;

FIG. 2 is a cross-sectional view illustrating a configuration of a power storage unit making up the power storage system according to the first embodiment;

FIG. 3 is a perspective view of a battery pack 20;

FIG. 4 is a circuit diagram illustrating a circuit configuration of the power storage system according to the first embodiment;

FIG. 5 is a block diagram illustrating a configuration of a power storage system according to a comparative example; and

FIG. 6 is a circuit diagram illustrating a circuit configuration of the power storage system according to the comparative example.

### DETAILED DESCRIPTION OF EMBODIMENTS

A specific embodiment of the present disclosure will be described in detail below with reference to the drawings. Note that the present disclosure is not limited to the following embodiment. Also, the following description and drawings are simplified as appropriate for clarity of description.

### First Embodiment

### Configuration of power storage unit

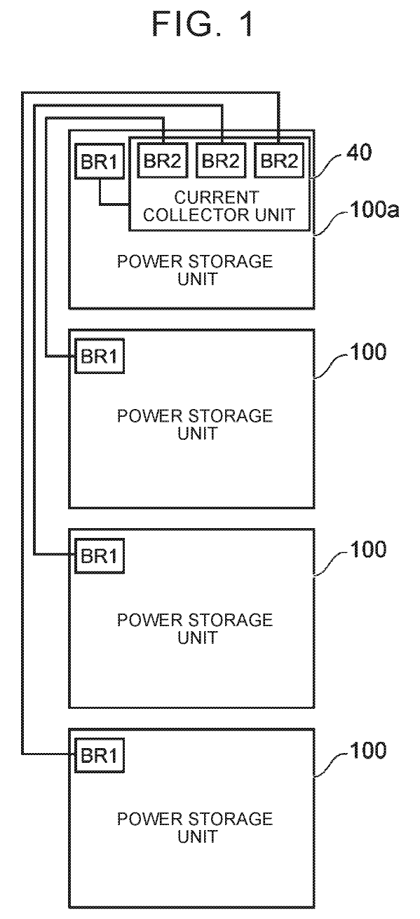

First, a configuration of a power storage system according to a first embodiment will be described with reference to FIG. 1. FIG. 1 is a block diagram illustrating the configuration of the power storage system according to the first embodiment.

As illustrated in FIG. 1, the power storage system according to the present embodiment includes a plurality of power storage units. As an example, the power storage system illustrated in FIG. 1 includes one power storage unit 100a and three power storage units 100. Here, the power storage unit (first power storage unit) 100a has a current collector unit 40 that is built in, and the power storage units (second power storage units) 100 do not have the current collector unit 40.

As illustrated in FIG. 1, the power storage unit 100a and the power storage units 100 each include a breaker (first breaker) BR1, and are connected to the current collector unit 40 built into the power storage unit 100a via the breakers BR1.

Also, the current collector unit 40 built into the power storage unit 100a has three breakers (second breakers) BR2 for connection to each of the power storage units 100.

As illustrated in FIG. 1, the current collector unit 40 built into the power storage unit 100a is connected to each of the power storage units 100 via one breaker BR1 and one breaker BR2. On the other hand, the current collector unit 40 built into the power storage unit 100a is connected to the power storage unit 100a via just one breaker BR1.

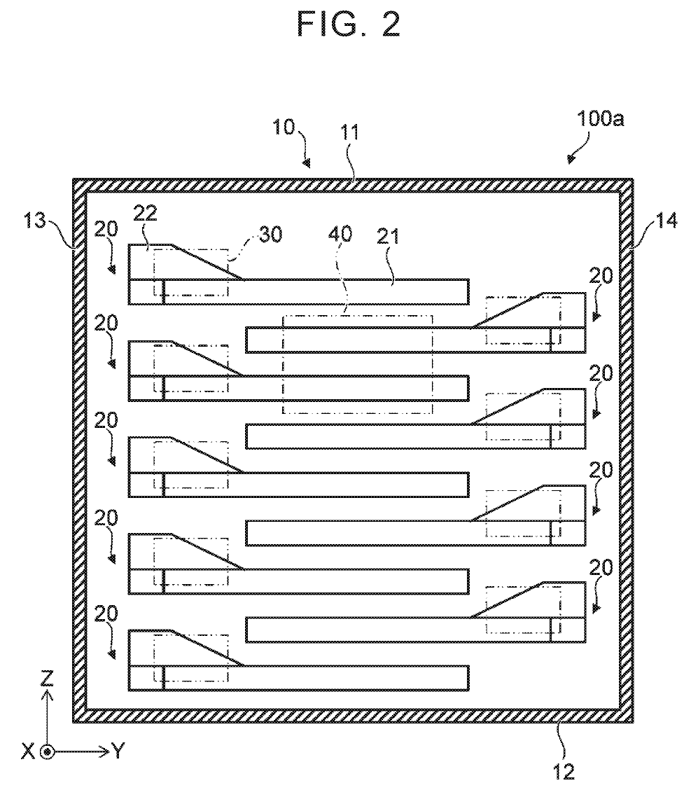

Now, the configuration of the power storage unit 100a that makes up the power storage system will be described. FIG. 2 is a cross-sectional view illustrating the configuration of the power storage unit making up the power storage system according to the first embodiment.

Note that the right-handed XYZ orthogonal coordinate system in FIG. 2 is provided merely for convenience in describing positional relations among the components, as a matter of course. In FIG. 2, a positive Z-axis direction is generally a vertically upward direction, and an XY plane is a horizontal plane, which applies to all the drawings.

The power storage unit 100a making up the power storage system according to the present embodiment is a power storage unit that can be installed outdoors, for example. As illustrated in FIG. 2, the power storage unit 100a includes a plurality of battery packs 20 inside a housing 10. Also, as indicated by long dashed double-short dashed lines in FIG. 2, each of the battery packs 20 includes a controller 30 on a negative X-axis direction side. Further, the power storage unit 100a includes the current collector unit 40 in the housing 10 between the controllers 30 disposed side by side in a Y-axis direction on the negative X-axis direction side of the battery packs 20.

Note that in the present embodiment, nine battery packs 20 are housed in the housing 10, however, the number of battery packs 20 is not limited in particular, as long as more than one.

Also, the configuration of the power storage units 100 is the same as that of the power storage unit 100a, except that the current collector unit 40 is not provided.

As illustrated in FIG. 2, the housing 10 has a rectangular cuboid shape, i.e., a box shape, and is made up of a top face portion 11, a bottom face portion 12, a front face portion 13, a rear face portion 14, and a pair of side face portions disposed at both ends in an X-axis direction but omitted from illustration. The housing 10 is made of metal plates such as steel plates or the like, for example.

The battery pack 20 is, for example, a lithium-ion battery, and is a battery pack for vehicular use.

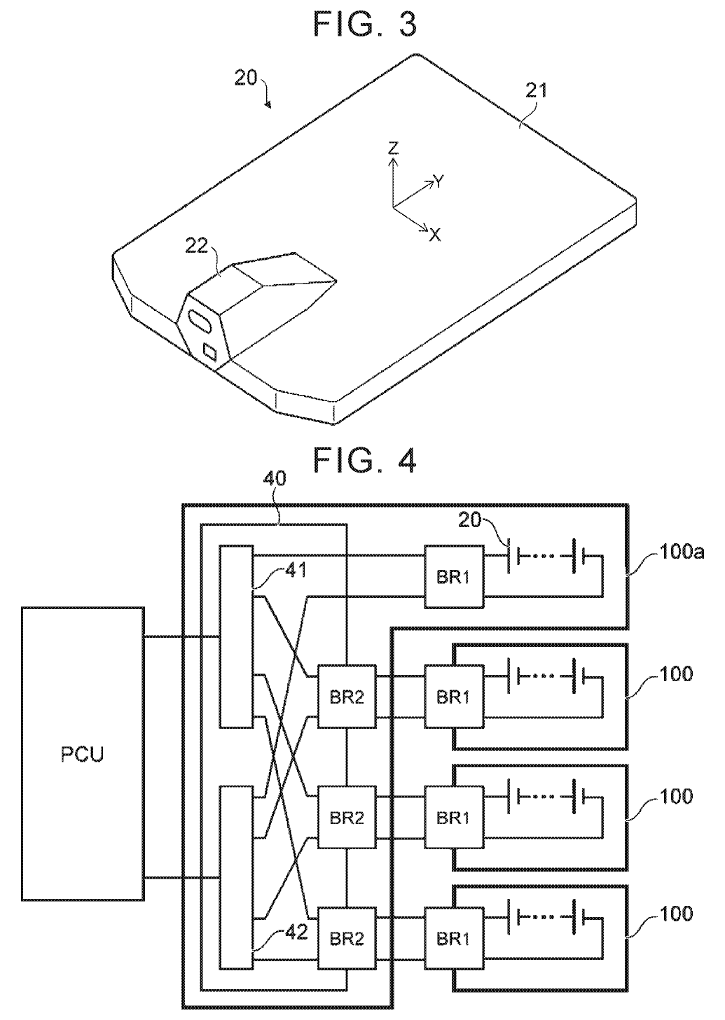

Now, FIG. 3 is a perspective view of the battery pack 20. As illustrated in FIG. 3, the battery pack 20 includes a battery module 21 and a protrusion 22.

As illustrated in FIG. 3, the battery module 21 has a substantially rectangular cuboid shape. The battery module 21 is a main unit of the battery pack 20 and is made up of a plurality of cell stacks arrayed in, for example, the X-axis direction or the Y-axis direction.

As illustrated in FIG. 3, the protrusion 22 is provided at one end of the battery module 21 in the Y-axis direction so as to protrude upward. The protrusion 22 houses electrical equipment such as, for example, relay circuits, fuses, current sensors, and so forth.

As illustrated in FIG. 2, the battery packs 20 are stacked in an up-down direction (Z-axis direction) and housed in the housing 10 such that the protrusions 22 are alternately disposed on opposite sides in the Y-axis direction. In other words, the battery packs 20 are stacked in the up-down direction such that the protrusions 22 alternately protrude from opposite outer sides. Accordingly, the height and the center of gravity of the power storage unit are lower, thereby improving vibration withstanding capabilities of the power storage unit.

### Circuit Configuration of Power Storage Unit

Next, a circuit configuration of the power storage system according to the first embodiment will be described with reference to FIG. 4. FIG. 4 is a circuit diagram illustrating the circuit configuration of the power storage system according to the first embodiment.

As illustrated in FIG. 4, in the power storage unit 100a and each of the power storage units 100, cathodes and anodes of the battery packs 20 connected in series are each connected to a breaker BR1.

The cathode and the anode of each of the power storage units 100 are connected via respective breakers BR1 to the breakers BR2 of the current collector unit 40 built into the power storage unit 100a. Now, as illustrated in FIG. 4, the current collector unit 40 includes a cathode connecting portion 41 and an anode connecting portion 42, in addition to three breakers BR2.

As illustrated in FIG. 4, the cathode of each of the power storage units 100 is connected to the cathode connecting portion 41 of the current collector unit 40 via one breaker BR1 and one breaker BR2. The anode of each of the power storage units 100 is connected to the anode connecting portion 42 of the current collector unit 40 via one breaker BR1 and one breaker BR2.

On the other hand, the cathode of the power storage unit 100a, into which the current collector unit 40 is built, is connected to the cathode connecting portion 41 of the current collector unit 40 via just one breaker BR1. On the other hand, the anode of the power storage unit 100a is connected to the anode connecting portion 42 of the current collector unit 40 via just the one breaker BR1.

As illustrated in FIG. 4, the cathode connecting portion 41 and the anode connecting portion 42 of the current collector unit 40 are connected to, for example, a power control unit PCU.

### Configuration of Power Storage Unit according to Comparative Example

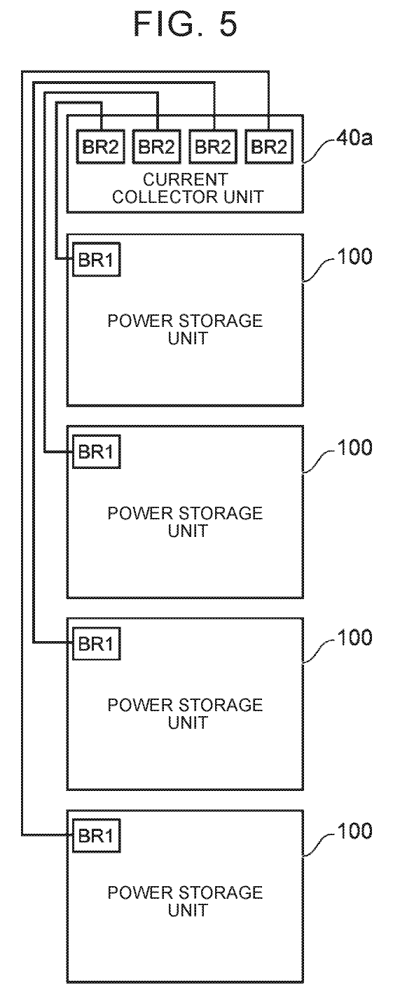

Next, a configuration of a power storage system according to a comparative example will be described with reference to FIG. 5. FIG. 5 is a block diagram illustrating the configuration of the power storage system according to the comparative example.

As illustrated in FIG. 5, the power storage system according to the comparative example includes four power storage units 100 that are included in the power storage system illustrated in FIG. 1, and also includes a current collector unit 40a that is separate from the power storage units 100.

As illustrated in FIG. 5, each of the power storage units 100 includes a breaker BR1 and is connected to the current collector unit 40a via the breaker BR1.

Also, as illustrated in FIG. 5, the current collector unit 40a has four breakers BR2 for connection to the power storage units 100. The current collector unit 40a is connected to each of the power storage units 100 via one breaker BR1 and one breaker BR2.

Note that each of the power storage units 100 can be used alone as a power storage device. When the power storage unit 100 is used alone, the current collector unit 40a is unnecessary. On the other hand, in the power storage system including multiple power storage units 100, the current collector unit 40a is necessary.

### Circuit Configuration of Power Storage Unit according to Comparative Example

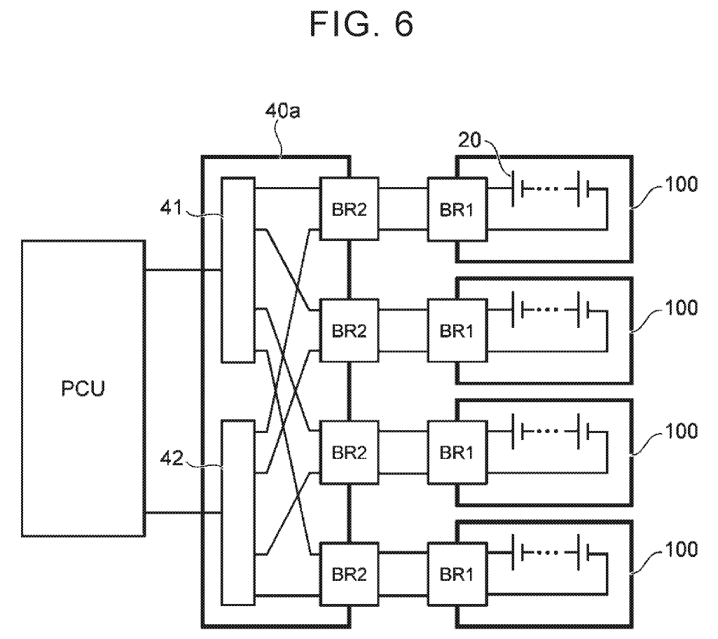

Next, a circuit configuration of the power storage system according to the comparative example will be described with reference to FIG. 6. FIG. 6 is a circuit diagram illustrating the circuit configuration of the power storage system according to the comparative example.

As illustrated in FIG. 6, in each of the power storage units 100, the cathodes and the anodes of the battery packs 20 connected in series are each connected to a breaker BR1.

The cathode and the anode of each of the power storage units 100 are each connected to one breaker BR2 of the current collector unit 40a via one breaker BR1. Now, as illustrated in FIG. 6, the current collector unit 40a includes the cathode connecting portion 41 and the anode connecting portion 42, in addition to four breakers BR2.

As illustrated in FIG. 6, the cathode of each of the power storage units 100 is connected to the cathode connecting portion 41 of the current collector unit 40a via one breaker BR1 and one breaker BR2. The anode of each of the power storage units 100 is connected to the anode connecting portion 42 of the current collector unit 40a via one breaker BR1 and one breaker BR2.

As illustrated in FIG. 6, the cathode connecting portion 41 and the anode connecting portion 42 of the current collector unit 40a are connected to, for example, the power control unit PCU.

### Effects of Power Storage System according to First Embodiment

Next, the effects of the power storage system according to the present embodiment will be described. In the power storage system according to the present embodiment illustrated in FIGS. 1 and 4, the current collector unit 40 is built into the power storage unit 100a, and accordingly the size of the power storage system as a whole can be reduced as compared with the power storage system according to the comparative example illustrated in FIGS. 5 and 6.

Furthermore, the current collector unit 40 is built into the power storage unit 100a, and accordingly there is no need to provide a breaker BR2 for the power storage unit 100a, and the size of the current collector unit 40 can also be reduced. Specifically, in the power storage system according to the comparative example illustrated in FIGS. 5 and 6, the current collector unit 40a includes four breakers BR2. In contrast, in the power storage system according to the present embodiment illustrated in FIGS. 1 and 4, the current collector unit 40 includes three breakers BR2. That is to say, in the power storage system according to the present embodiment, the number of breakers BR2 included in the current collector unit 40 can be reduced by one, and the size of the current collector unit 40 can be reduced.

Note that the present disclosure is not limited to the above embodiment, and can be modified as appropriate without departing from the spirit and scope thereof.

What is claimed is:

1. A power storage system comprising:
a plurality of power storage units, each including a plurality of battery packs; and
a current collector unit connected to each of the power storage units to perform current collection, wherein
each of the power storage units includes a first breaker and is connected to the current collector unit via the first breaker, and
the current collector unit
is built into a first power storage unit from among the power storage units,
includes a second breaker for connecting to each of second power storage units other than the first power storage unit, from among the power storage units,
is connected to each of the second power storage units via the first and the second breakers, and
is connected to the first power storage unit via just the first breaker.

2. The power storage system according to claim 1, wherein,
in each of the power storage units,
each of the battery packs includes a battery module that is substantially rectangular cuboid shaped, and a protrusion protruding upward from one end of the battery module, and
the battery packs are stacked in an up-down direction and housed in a housing such that the protrusions are alternately disposed on opposite sides.
